(19) United States
(12) Patent Application Publication
(10) Pub. No.: US 2017/0057072 A1
(43) Pub. Date: Mar. 2, 2017

(54) HAND-HELD POWER TOOL

(71) Applicant: Hilti Aktiengesellschaft, Schaan (LI)

(72) Inventors: Markus Holubarsch, Karlsruhe (DE); Ferdinand Kristen, Gilching (DE); Stefan Schmid, Untermuehlhausen (DE); Benjamin Lederle, Buchloe (DE)

(21) Appl. No.: 15/120,269

(22) PCT Filed: Feb. 11, 2015
(86) PCT No.: PCT/EP2015/052813

§ 371 Date: Aug. 19, 2016

(30) Foreign Application Priority Data
Feb. 21, 2014 (EP) 14156105.0

(51) Int. Cl. B25D 17/06; B25D 16/00

(52) U.S. Cl. CPC B25D 17/06; B25D 16/00; B25D 2217/0023; B25D 2222/27; B25D 2222/31; B25D 2222/54; B25D 2250/345

(57) ABSTRACT

A hand-held power tool has a tool socket 2 to hold a tool on a working axis 11. A pneumatic striking mechanism 6 has an exciter piston 13 that is forced to move periodically along the working axis 11 by a motor 5 and it also has a striker 14 that is coupled to the exciter piston 13 via a pneumatic chamber 18. The exciter piston 13 has a cylindrical main body 21 made of a polymer. One or more rings 24 containing copper surround the main body 21. The rings 24 protrude from the main body 21 in the radial direction.

The present invention relates to a hand-held power tool with a pneumatic striking mechanism, especially a hammer drill.

### BACKGROUND

A hand-held power tool of the generic type is described in British patent application GB 2063141 A. The striking mechanism has an exciter piston that is periodically moved back and forth along an axis by an eccentric drive. The exciter piston is installed in a guide tube that is coaxial to the axis. A striker that is likewise installed in the guide tube is coupled to the movement of the exciter piston by means of a pneumatic spring formed between the exciter piston and the striker. The exciter piston and the guide tube are made of a plastic in order to improve the thermal efficiency of the striking mechanism. The use of the same material for the guide tube and the exciter piston ensures that they have the same thermal coefficient of expansion and this, in turn, makes it possible to manufacture the exciter piston with a small gap width.

### SUMMARY OF THE INVENTION

The hand-held power tool according to the invention has a tool socket to hold a tool on a working axis. A pneumatic striking mechanism has an exciter piston that is forced to move periodically along the working axis by means of a motor and it also has a striker that is coupled to the exciter piston via a pneumatic chamber. The exciter piston has a cylindrical main body made of a polymer. One or more rings containing copper surround the main body. The rings protrude from the main body in the radial direction. The rings hold the main body made of plastic at a distance from a guide tube. The rings containing copper can reduce the friction value to such an extent as to overcompensate for an elevated thermal loss as well as for a tension caused by different thermal coefficients of expansion. The exciter piston preferably runs in a guide tube made of a polymer that thermally insulates the pneumatic contain in the radial direction.

### BRIEF DESCRIPTION OF THE DRAWINGS

The description below explains the invention making reference to embodiments and figures given by way of example. The figures show the following:

FIG. 1 a hammer drill,

FIG. 2 a striking mechanism.

Unless otherwise indicated, identical or functionally equivalent elements are designated by the same reference numerals in the figures.

### DETAILED DESCRIPTION

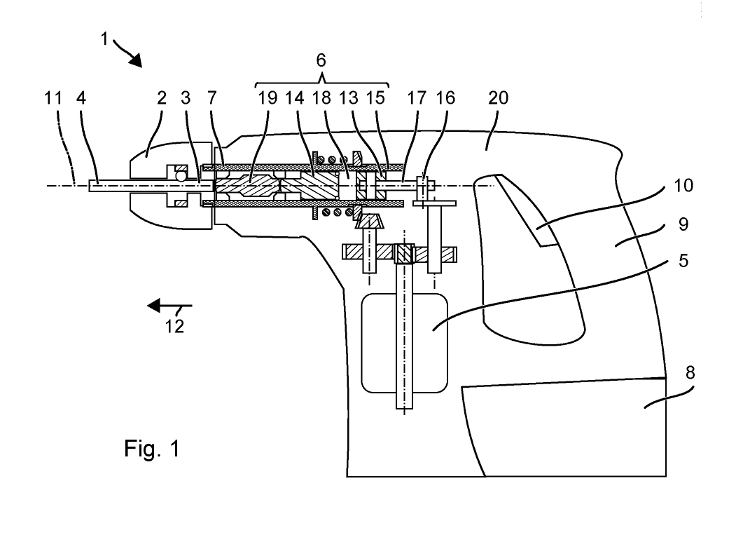

FIG. 1 schematically shows a hammer drill 1 as an example of a chiseling hand- held power tool. The hammer drill 1 has a tool socket 2 into which a shank end 3 of a tool, for example, a drill bit 4, can be inserted. A primary drive of the hammer drill 1 is in the form of a motor 5 that drives a striking mechanism 6 and a driven shaft 7. A battery pack 8 or a mains line supplies the motor 5 with power. A user can guide the hammer drill 1 by means of a handle 9 and can put the hammer drill 1 into operation by means of a system switch 10. During operation, the hammer drill 1 rotates the drill bit 4 continuously around a working axis 11 and, in this process, can hammer the drill bit 4 into a substrate in the striking direction 12 along the working axis 11.

The striking mechanism 6 is a pneumatic striking mechanism 6. An exciter piston 13 and a striker 14 run movably along the working axis 11 in a guide tube 15 in the striking mechanism 6. The exciter piston 13 is coupled to the motor 5 via an eccentric 16 and it is forced to execute a periodical, linear movement. A connecting rod 17 connects the eccentric 16 to the exciter piston 13. A pneumatic spring that is formed by a pneumatic chamber 18 between the exciter piston 13 and the striker 14 couples a movement of the striker 14 to the movement of the exciter piston 13. The striker 14 can strike a rear end of the drill bit 4 directly or it can transmit some of its pulse to the drill bit 4 indirectly via an essentially stationary intermediate striker 19. The striking mechanism 6 and preferably the other drive components are arranged inside a machine housing 20.

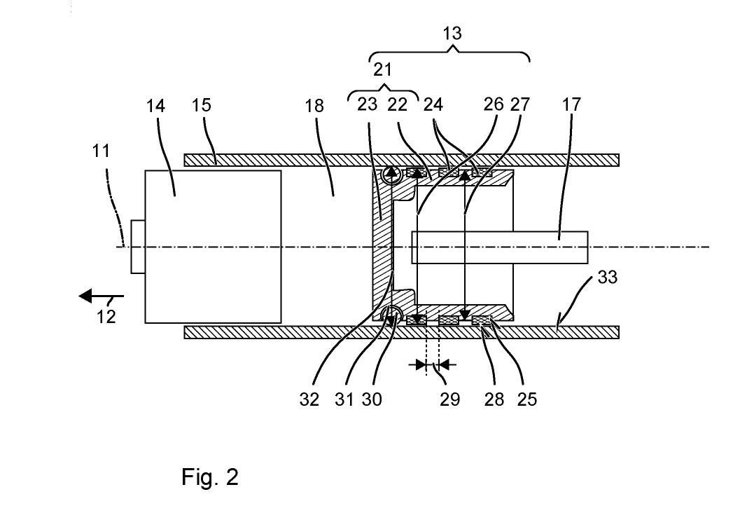

The exciter piston 13 has a pot-shaped main body 21 that is oriented coaxially to the working axis 11 (FIG. 2). The hollow main body 21 has an essentially cylindrical jacket 22 and is closed off in the striking direction 12 by a circular end face 23. The main body 21 is made completely of a polymer.

One end of the connecting rod 17 is supported rotatably or pivotably inside the exciter piston 13.

The exciter piston 13 has one or more rings 24 containing copper that surround the jacket 22 of the main body 21. The exciter piston 13, shown here by way of example, is provided with three identical rings 24 that are arranged so as to be offset along the working axis 11. The jacket 22 can be provided with annular grooves 25 into which the rings 24 are sunk. The outer diameter 26 of the rings 24 is larger than the outer diameter 27 of the main body 21. Preferably, the difference between the outer diameters is between 0.2 mm and 1.0 mm.

The rings 24 cover between 25% and 70% of the jacket 22. Preferably, their radial outer surface 28 is cylindrical, that is to say, parallel to the working axis 11. The sliding surface formed by the rings 24 is large enough to support the exciter piston 13 on the guide tube 15 in the radial direction. However, the rings 24 do not yet form a continuous thermal bridge over the length of the exciter piston 13. Preferably, there are several rings 24 and they are separated from each other along the working axis 11 by a gap 29.

The rings 24 containing copper are preferably made of bronze or brass.

The exciter piston 13 is also provided with a sealing ring 30 made of an elastic material, for example, rubber. The sealing ring 30 is laid into a correspondingly annular groove 31 near the end face 23. The sealing ring 30 has the largest outer diameter 32 of the components of the exciter piston 13.

The guide tube 15 is preferably made completely of a polymer or at least the inner surface 33 of the guide tube 15 is made of a polymer. The guide tube 15 made of polymer has a low thermal conductivity, thereby reducing thermal losses of the pneumatic chamber 18.

What is claimed is:

1-5. (canceled)

6. A hand-held power tool comprising:
a tool socket to hold a tool on a working axis;
a motor;
a pneumatic striking mechanism having an exciter piston forced to move periodically along the working axis by the motor and also having a striker coupled to the exciter piston via a pneumatic chamber, the exciter piston having a cylindrical main body made of a polymer; and
at least one ring containing copper surround the main body, the at least one ring protruding from the main body in the radial direction.

7. The hand-held power tool as recited in claim 6 wherein the at least one ring includes a plurality of rings and an outer diameter of the rings containing copper is between 0.2 mm and 1.0 mm, and larger than an outer diameter of the main body.

8. The hand-held power tool as recited in claim 6 wherein the at least one ring includes a plurality of rings and the rings cover between 25% and 70% of the jacket of the main body.

9. The hand-held power tool as recited in claim 6 wherein the at least one ring includes a plurality of rings and a gap is provided between the rings along the working axis.

10. The hand-held power tool as recited in claim 6 wherein the exciter piston runs in a guide tube made of a polymer.

11. The hand-held power tool as recited in claim 6 wherein the at least one ring includes a plurality of rings protruding from the main body in the radial direction.
